(19) United States
(12) Patent Application Publication
(10) Pub. No.: US 2024/0371573 A1
(43) Pub. Date: Nov. 7, 2024

(54) Intermediate-Circuit Busbar Arrangement With Integrated Y Plate Capacitors for High-Frequency Interference Suppression

(71) Applicant: BAYERISCHE MOTOREN WERKE AKTIENGESELLSCHAFT, München (DE)

(72) Inventors: Nikolas BAUER, Muenchen (DE); Wolfgang OBLINGER, Ingolstadt (DE)

(21) Appl. No.: 18/689,561

(22) PCT Filed: Oct. 21, 2022
(86) PCT No.: PCT/EP2022/079335

§ 371 Date: Mar. 6, 2024

(30) Foreign Application Priority Data
Nov. 17, 2021 (DE) 10 2021 130 017.7

(51) Int. Cl. H01G 4/38; B60R 16/03; H01R 25/16; H02M 1/44; H02M 7/00

(52) U.S. Cl. CPC H01G 4/38; B60R 16/03; H01R 25/161; H02M 7/003; H02M 1/44

(57) ABSTRACT

A connection device for an intermediate circuit of a high-voltage vehicle electrical system of a motor vehicle for electrically connecting high-voltage components of the high-voltage vehicle electrical system includes a first busbar electrically connecting first poles of the high-voltage components, a second busbar electrically connecting second poles of the high-voltage components, Y interference-suppression capacitors electrically connected to the busbars and electrically connected to a reference potential and which are designed to damp interference frequencies emitted by at least one of the high-voltage components. The first and second busbars have first and second planar areal portions, respectively, with the first and second areal portions overlapping each other, and the connection device has two electrically conductive planar areal parts that can be connected to the reference potential. First and second areal parts overlap with the first and second areal portions, respectively, such that first and second Y interference-suppression capacitors are formed.

### BACKGROUND AND SUMMARY

The invention relates to a connection device for an intermediate circuit of a high-voltage on-board electrical system of a motor vehicle for electrically connecting high-voltage components of the high-voltage on-board electrical system. The connection device has a first busbar for electrically connecting first poles of the high-voltage components and a second busbar for electrically connecting second poles of the high-voltage components. Moreover, the connection device has Y interference-suppression capacitors which are electrically connected to the busbars and to a reference potential and which are designed to damp interference frequencies emitted by at least one of the high-voltage components. The invention moreover relates to an intermediate circuit and to a high-voltage on-board electrical system.

High-voltage on-board electrical systems for electrified motor vehicles, that is to say electric or hybrid vehicles, are of great interest at present. Such high-voltage on-board electrical systems usually have a plurality of high-voltage components, for example, a high-voltage energy store, an inverter and an electrical drive unit, which are electrically connected via busbars. The electrical energy store and the inverter are in this case electrically connected via an intermediate circuit which has at least one intermediate-circuit capacitor.

Furthermore, such high-voltage on-board electrical systems usually have filtering measures, for example, in the form of interference-suppression capacitors, integrated in them, which filtering measures can be used to damp interference frequencies. Such interference frequencies may be emitted, for example, by switching elements of the inverter. Interference-suppression capacitors that may, for example, be used are wound capacitors in the form of film capacitors placed at suitable topological points in the high-voltage on-board electrical system. Due to extensive series inductances of the capacitors and of their electrical connection path, respectively, the frequencies damped by such film capacitors are typically limited to a maximum frequency, for example 1 MHz. If the switching elements of the inverter are in the form of wide-bandgap semiconductors, however, they emit frequencies of considerably above 1 MHz in their commutation cell and in their switching edge.

It is an object of the present invention to provide a solution as to how interference frequencies in a high-voltage on-board electrical system of a motor vehicle can be damped in a simple and reliable manner.

This object is achieved according to the invention by a connection device, an intermediate circuit and a high-voltage on-board electrical system having the features according to the respective independent patent claims. Advantageous embodiments of the invention are the subject of the dependent patent claims, the description and the figures.

A connection device according to the invention for an intermediate circuit of a high-voltage on-board electrical system of a motor vehicle is used to electrically connect high-voltage components of the high-voltage on-board electrical system. The connection device has a first busbar for electrically connecting first poles of the high-voltage components and a second busbar for electrically connecting second poles of the high-voltage components. Moreover, the connection device has Y interference-suppression capacitors which are electrically connected to the busbars and are able to be electrically connected to a reference potential and which are designed to damp interference frequencies emitted by at least one of the high-voltage components. The first busbar has a first planar areal portion and the second busbar has a second planar areal portion arranged such that it overlaps with the first areal portion. Furthermore, the connection device has two electrically conductive planar areal parts which are able to be connected to the reference potential, a first of which areal parts is arranged such that it overlaps with the first areal portion to form a first Y interference-suppression capacitor and a second of which areal parts is arranged such that it overlaps with the second areal portion to form a second Y interference-suppression capacitor.

Moreover, the invention pertains to an intermediate circuit for a high-voltage on-board electrical system of a motor vehicle, having at least one connection device according to the invention and at least one intermediate-circuit capacitor, wherein the at least one intermediate-circuit capacitor is electrically connected to the busbars. A high-voltage on-board electrical system according to the invention comprises an intermediate circuit according to the invention and high-voltage components electrically connected to the intermediate circuit. The high-voltage components are in particular an electrical high-voltage energy store, which can be used as a traction accumulator for an electrified motor vehicle, and an inverter connected to the electrical high-voltage energy store via the intermediate circuit. The at least one intermediate-circuit capacitor is in this case in particular integrated in a busbar arrangement formed of the first and the second busbar and is electrically connected to the busbars. The first, for example, positive-side, busbar is in this case electrically connected to the first poles, for example positive poles, of the high-voltage components and the second, for example, negative-side, busbar is electrically connected to the second poles, for example, negative poles, of the high-voltage components with the interposition of the at least one intermediate-circuit capacitor.

The at least one intermediate-circuit capacitor of the intermediate circuit is designed to temporarily store and to smooth the DC voltage provided by the electrical high-voltage energy store. The at least one intermediate-circuit capacitor can, for example, be in the form of a film capacitor. The inverter is designed to convert the DC voltage temporarily stored in the intermediate-circuit capacitor into an AC voltage for an electrical drive unit of the high-voltage on-board electrical system. For this purpose, the inverter has switching elements in the form of semiconductor switches.

These switching elements of the inverter form, for example, interference transmitters or interference sources which emit interference frequencies. In order to damp these interference frequencies, the connection device has two Y interference-suppression capacitors. The first, for example, positive-side, Y interference-suppression capacitor is in this case connected to the first busbar and the reference potential, for example, ground, and the second, for example, negative-side, Y interference-suppression capacitor is connected to the second busbar and the reference potential. In particular in the case of semiconductor switches in the form of wide-bandgap semiconductors, these interference frequencies are in a frequency range which can become all the more difficult to damp the further away the interference-suppression capacitors are from the interference transmitter.

In order to be able to reliably damp the interference frequencies, the Y interference-suppression capacitors are formed with the aid of the busbar arrangement and are therefore arranged spatially near to the interference transmitters. For this purpose, the busbars have the planar, for example, rectangular, areal portions which each have a bottom side and a top side. In the busbar arrangement, the busbars are guided one over the other in such a way that the areal portions are arranged in an overlapping or overlaying manner, in particular in a plane-parallel manner, and are electrically insulated from one another. In this case, for example, the bottom side of the first areal portion faces toward the top side of the second areal portion.

In order to form the Y interference-suppression capacitors, the connection device has the two electrically conductive, for example, metal, planar areal parts. In this case, the planar areal parts and the planar areal portions are in particular to be understood to mean stiff or rigid areal elements, the thickness of which is considerably less than their length and width. The first areal part is in this case arranged such that it overlaps, in particular in a plane-parallel manner, with the top side of the first areal portion and the second areal part is arranged such that it overlaps, in particular in a plane-parallel manner, with the bottom side of the second areal portion. A spacing is formed between the areal parts and the respective areal portions such that the areal parts and the respective areal portions form capacitor plates of a respective plate capacitor. These plate capacitors form the Y interference-suppression capacitors.

For example, an insulation layer or an electrically insulating material which forms a dielectric of the respective Y interference-suppression capacitor is arranged between the respective electrically conductive areal part and the respective areal portion. In particular, the respective areal portions and the respective areal parts are mechanically connected to the electrically insulating material to form a one-piece assembly. The electrically insulating material can, for example, be an insulating film or an insulating coating. This electrically insulating material can be used to fasten the areal parts to the busbar arrangement such that the connection device is in the form of the one-piece, easy-to-mount assembly.

This configuration of the connection device advantageously makes it possible to provide a low-inductance electrical connection between the high-voltage components. Furthermore, the Y interference-suppression capacitors formed with the aid of the busbar arrangement are mounted spatially near to the interference transmitters and can therefore reliably filter the interference frequencies emitted by the interference transmitters. Moreover, this configuration of the Y interference-suppression capacitors using the busbar arrangement has the advantage that no additional structural elements in the form of film capacitors are required.

In particular, the two busbars have connection points for the poles of the high-voltage components, which connection points are in the form of edge portions of the busbars arranged at two opposite edges of the areal portions and folded with respect to the areal portions. For example, the connection point pair of the two busbars for one high-voltage component arranged at one edge of the respective areal portions can be formed by strip-shaped edge portions which are arranged on the respective areal portion, in particular perpendicularly, in a protruding manner and offset with respect to one another. In this case, the strips have a lesser width than the areal portions. The connection point pair of the two busbars for the other high-voltage component arranged at the other edge of the respective areal portions can for example be in the form of L-profile-shaped and/or T-profile-shaped edge portions, the width of which corresponds to the width of the respective areal portion.

In this case, provision can be made for the two areal parts to be in the form of sub-areas of an electrically conductive bent part, for example, of a bent sheet-metal part, which are bent to form an envelope, wherein the overlapping areal portions of the busbars are arranged in the envelope between the sub-areas. In order to produce the connection device, a single-piece unfolded sheet metal can thus be provided, for example, which is bent around the busbar arrangement to form the bent part in such a way that the sub-areas which form the two areal parts overlap with the areal portions of the busbars. The areal parts thus cover the busbar arrangement at least in the area of the areal portions. This bent part can then be connected to the reference potential. For example, one of the sub-areas of the bent part can be arranged lying on a cooler of the intermediate circuit, which cooler forms the reference potential, and can simultaneously be used for cooling the connection device. With the aid of such a bent part, the Y interference-suppression capacitors can be manufactured in a simple manner. In particular, the bent part is designed in such a way that it covers the busbar arrangement also in the area of at least one of the connection point pairs. Such a bent part moreover advantageously forms a shield for the busbar arrangement.

In one advantageous development of the connection device, a stack formed of the second areal part, the second areal portion, the first areal portion and the first areal part forms a carrier for the at least one intermediate-circuit capacitor of the intermediate circuit, which intermediate-circuit capacitor is able to be electrically connected to the busbars. The intermediate circuit is thus designed in such a way that the at least one intermediate-circuit capacitor is arranged on the carrier and connected to the busbars of the stack. For example, the first areal part and the first areal portion, which face toward the at least one intermediate-circuit capacitor, can in addition have passage openings for contacting the intermediate-circuit capacitor with the areal portions. The first areal part, which forms a carrier surface of the carrier for the at least one intermediate-circuit capacitor, thus has at least one passage opening in order to electrically connect the at least one intermediate-circuit capacitor to the first areal portion lying beneath it. Moreover, the first areal portion has at least one further passage opening in order to also electrically connect the at least one intermediate-circuit capacitor to the second areal portion lying beneath it.

The embodiments presented with respect to the connection device according to the invention and the advantages thereof accordingly apply to the intermediate circuit according to the invention and to the high-voltage on-board electrical system according to the invention.

Further features of the invention are evident from the claims, the figures and the description of the figures. The features and combinations of features mentioned above in the description, and the features and combinations of features mentioned below in the description of the figures and/or shown in the figures themselves, cannot only be used in the respectively specified combination but also in other combinations or by themselves.

The invention will now be explained in more detail on the basis of a preferred exemplary embodiment and with reference to the drawings.

### BRIEF DESCRIPTION OF THE DRAWINGS

FIG. 1 shows a schematic perspective illustration of one embodiment of a connection device;

FIG. 2 shows a schematic perspective illustration of one embodiment of an intermediate circuit having a connection device according to FIG. 1;

FIG. 3 shows a schematic perspective illustration of a busbar arrangement of the connection device; and

FIG. 4 shows a schematic illustration of the intermediate circuit during production.

### DETAILED DESCRIPTION OF THE DRAWINGS

Identical and functionally identical elements are provided with the same reference signs in the figures.

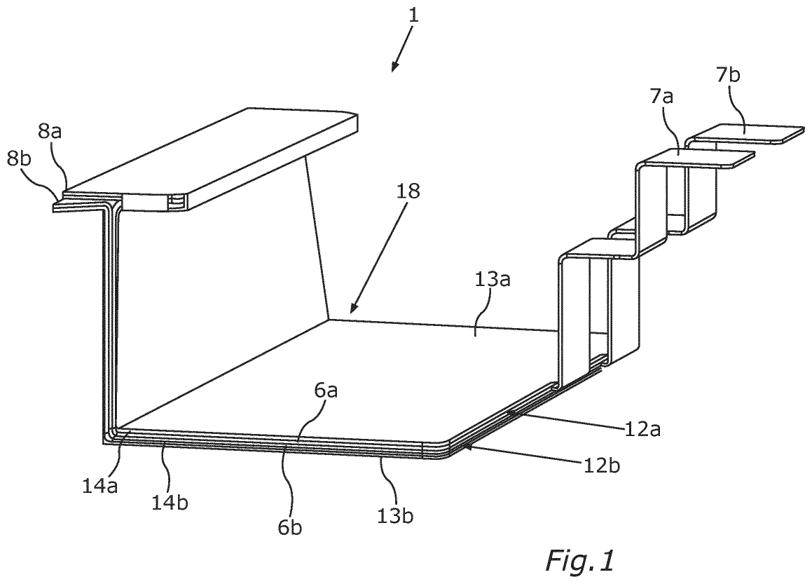

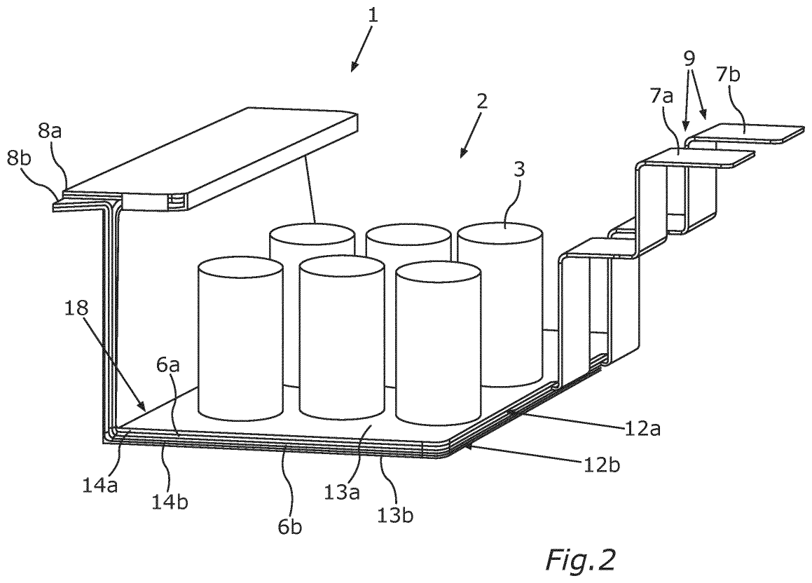

FIG. 1 shows a connection device 1 for an intermediate circuit 2 shown in FIG. 2 which can be used for a high-voltage on-board electrical system of an electrically drivable motor vehicle. The intermediate circuit 2 here has a plurality of intermediate-circuit capacitors 3 which are designed to couple DC voltage levels of two high-voltage components of the high-voltage on-board electrical system. The high-voltage components are in particular an electrical energy store and an inverter. The intermediate-circuit capacitors 3 are in particular in the form of film capacitors.

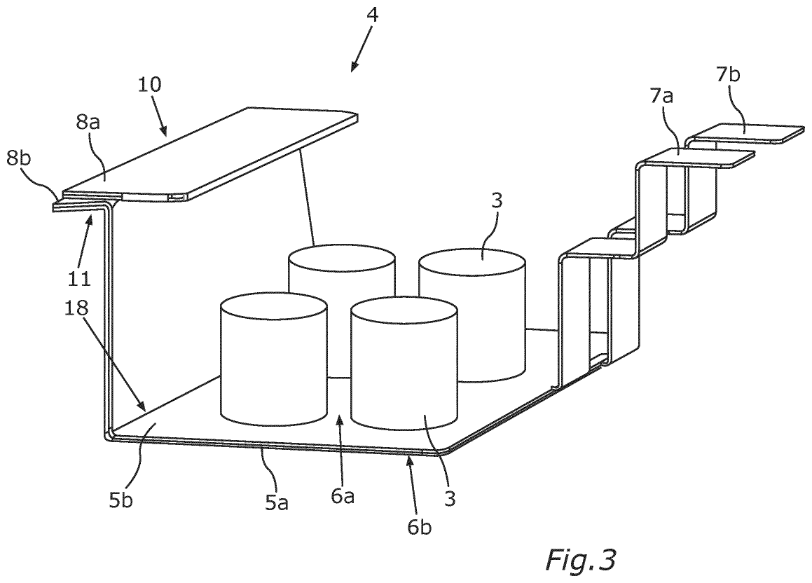

The connection device 1 has a busbar arrangement 4 shown on its own in FIG. 3 which has two busbars 5a, 5b. One of the busbars 5a, 5b is a positive-side busbar and electrically connects positive poles of the high-voltage components and another of the busbars 5a, 5b is a negative-side busbar and electrically connects negative poles of the high-voltage components. The intermediate-circuit capacitors 3 are electrically connected to the busbars 5a, 5b and are therefore connected between the high-voltage components.

The busbars 5a, 5b each have a planar areal portion 6a, 6b which are arranged such that they overlap one another. Moreover, the busbars 5a, 5b have connection points 7a, 7b, 8a, 8b, wherein the connection points 7a, 7b can be electrically connected to the first high-voltage component, for example, to the electrical energy store, and the connection points 8a, 8b can be electrically connected to the second high-voltage component, for example, to the inverter. The connection points 7a, 7b are in the form of strip-shaped, arbitrarily bent edge pieces 9 of the busbars 5a, 5b, which edge pieces are angled upward with respect to the areal portions 6a, 6b. In this case, the connection point 7a of the first busbar 5a, which connection point is arranged protruding from the first areal portion 6a, is arranged offset with respect to the connection point 7b of the second busbar 5b, which connection point is arranged protruding from the second areal portion 6b. The connection point 8a here is in the form of a T-profile-shaped edge piece 10 of the first busbar 5a, which edge piece protrudes perpendicularly upward from the first areal portion 6a, and the connection point 8b is in the form of an L-profile-shaped edge piece 11 of the second busbar 5b, which edge piece protrudes perpendicularly upward from the second areal portion 6b and is covered by the T-profile-shaped edge piece 10.

The connection device 1 additionally has two Y interference-suppression capacitors 12a, 12b which are formed using the areal portions 6a, 6b of the busbars 5a, 5b. In addition, the connection device 1 has two planar, electrically conductive areal parts 13a, 13b. The first areal part 13a is arranged such that it overlaps with the first areal portion 6a to form the first Y interference-suppression capacitor 12a and the second areal part 13b is arranged such that it overlaps with the second areal portion 6b to form the second Y interference-suppression capacitor 12b. A respective insulation layer 14a, 14b between the respective areal parts 13a, 13b and the corresponding areal portions 6a, 6b forms a dielectric of the respective Y interference-suppression capacitor 12a, 12b.

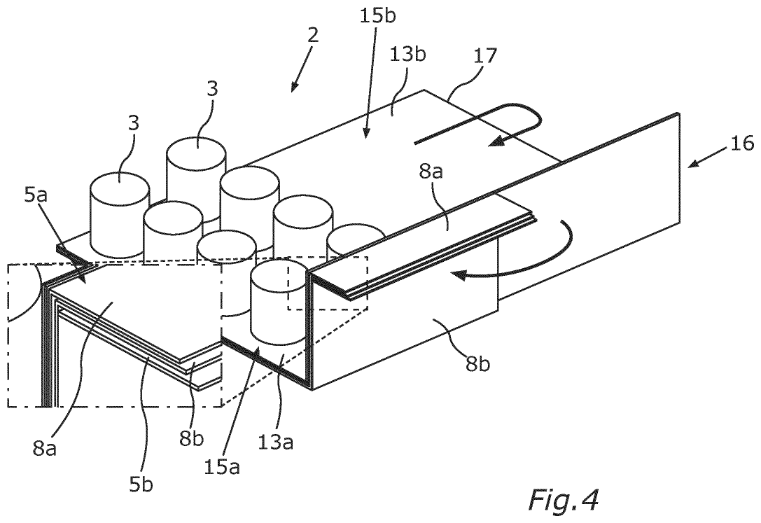

The areal parts 13a, 13b are in particular sub-areas 15a, 15b of a bent part 16 which is in particular in the form of a bent sheet-metal part. An unfolded sheet metal 17 of the bent part 16 is shown in FIG. 4. The unfolded sheet metal 17 is in this case bent along the arrows so as to produce an envelope which covers at least the areal portions 6a, 6b, in particular also the connection points 8a, 8b. The bent part 16 can therefore additionally form a shield for the busbar arrangement 4. Moreover, the areal parts 13a, 13b are already electrically connected by the bent part 16 and can therefore be connected to a reference potential in a simple manner. In addition, the second areal part 13b of the connection device 1 can, for example, be arranged lying on a component which is at the reference potential, for example, a cooler of the high-voltage on-board electrical system.

The connection device 1 moreover forms a carrier 18 for the intermediate-circuit capacitors 3 in the area of the areal parts 13a, 13b and areal portions 6a, 6b. In addition, the intermediate-circuit capacitors 3 are placed on the first areal part 13a and electrically connected to the first areal portion 6a via passage openings in the first areal part 13a and electrically connected to the second areal portion 6b via additional passage openings in the first areal portion 6a.

1.-10. (canceled)

11. A connection device for an intermediate circuit of a high-voltage on-board electrical system of a motor vehicle for electrically connecting high-voltage components of the high-voltage on-board electrical system, the connection device comprising:
a first busbar for electrically connecting first poles of the high-voltage components;
a second busbar for electrically connecting second poles of the high-voltage components;
Y interference-suppression capacitors which are electrically connected to the first and second busbars and are able to be electrically connected to a reference potential and which are designed to damp interference frequencies emitted by at least one of the high-voltage components;
wherein
the first busbar has a first planar areal portion and the second busbar has a second planar areal portion arranged overlapped with the first planar areal portion, and
the connection device has two electrically conductive planar areal parts which are able to be connected to the reference potential, a first electrically conductive planar areal part of the electrically conductive planar areal parts is arranged overlapped with the first planar areal portion to form a first Y interference-suppression capacitor and a second electrically conductive planar areal part is arranged overlapped with the second areal portion to form a second Y interference-suppression capacitor.

12. The connection device according to claim 11, wherein an insulation layer, which forms a dielectric of a respective Y interference-suppression capacitor, is arranged between a respective electrically conductive areal part and a respective areal portion.

13. The connection device according to claim 12, wherein the respective areal portion and the respective areal part are mechanically connected to the respective insulation layer to form a one-piece assembly.

14. The connection device according to claim 11, wherein the two electrically conductive planar areal parts are in a form of sub-areas of an electrically conductive bent part which are bent to form an envelope, wherein the overlapping areal portions of the first and second busbars are arranged in the envelope between the sub-areas.

15. The connection device according to claim 12, wherein the two electrically conductive planar areal parts are in a form of sub-areas of an electrically conductive bent part which are bent to form an envelope, wherein the overlapping areal portions of the first and second busbars are arranged in the envelope between the sub-areas.

16. The connection device according to claim 13, wherein the two electrically conductive planar areal parts are in a form of sub-areas of an electrically conductive bent part which are bent to form an envelope, wherein the overlapping areal portions of the first and second busbars are arranged in the envelope between the sub-areas.

17. The connection device according to claim 11, wherein a stack formed of the second areal part, the second areal portion, the first areal portion and the first areal part forms a carrier for at least one intermediate-circuit capacitor of the intermediate circuit, the at least one intermediate-circuit capacitor being able to be electrically connected to the busbars.

18. The connection device according to claim 12, wherein a stack formed of the second areal part, the second areal portion, the first areal portion and the first areal part forms a carrier for at least one intermediate-circuit capacitor of the intermediate circuit, the at least one intermediate-circuit capacitor being able to be electrically connected to the busbars.

19. The connection device according to claim 13, wherein a stack formed of the second areal part, the second areal portion, the first areal portion and the first areal part forms a carrier for at least one intermediate-circuit capacitor of the intermediate circuit, the at least one intermediate-circuit capacitor being able to be electrically connected to the busbars.

20. The connection device according to claim 15, wherein the first areal part and the first areal portion, which face toward the at least one intermediate-circuit capacitor, have passage openings for contacting the intermediate-circuit capacitor with the areal portions.

21. The connection device according to claim 11, wherein the two busbars have connection points for the poles of the high-voltage components, the connection points being in the form of edge portions of the busbars arranged at two opposite edges of the areal portions and folded with respect to the areal portions.

22. The connection device according to claim 12, wherein the two busbars have connection points for the poles of the high-voltage components, the connection points being in the form of edge portions of the busbars arranged at two opposite edges of the areal portions and folded with respect to the areal portions.

23. The connection device according to claim 13, wherein the two busbars have connection points for the poles of the high-voltage components, the connection points being in the form of edge portions of the busbars arranged at two opposite edges of the areal portions and folded with respect to the areal portions.

24. An intermediate circuit for a high-voltage on-board electrical system of a motor vehicle, having at least one intermediate-circuit capacitor and at least one connection device according to claim 11, wherein the at least one intermediate-circuit capacitor is electrically connected to the busbars.

25. The intermediate circuit according to claim 24, wherein the intermediate circuit has a cooler forming the reference potential for the Y interference-suppression capacitors, wherein one of the areal parts is arranged lying on the cooler and electrically connected to the reference potential.

26. A high-voltage on-board electrical system for a motor vehicle having at least two high-voltage components and an intermediate circuit according to claim 24, wherein the high-voltage components are electrically connected to the intermediate circuit.
